(19) United States
(12) Patent Application Publication
(10) Pub. No.: US 2008/0071681 A1
(43) Pub. Date: Mar. 20, 2008

(54) Dynamic Credit and Check Card

(76) Inventor: ATM Shafiqul Khalid, Redmond, WA (US)

Correspondence Address: ATM SHAFIQUL KHALID, 17446 NE 28TH ST., REDMOND, WA, 98052, US

(21) Appl. No.: 11/854,545

(22) Filed: Sep. 13, 2007

Related U.S. Application Data
(60) Provisional application No. 60/844,699, filed on Sep. 15, 2006.

(51) Int. Cl. G06Q 30/00

(52) U.S. Cl. 705/41; 235/494

(57) ABSTRACT

A method is provided here that can make sure that account information used for a transaction at a given time can't be reused at a different time. The method attaches a dynamic information generator in place of some static information associated with the account. How the dynamic information can be interpreted at user end and processing end are also outlined here.

### CROSS REFERENCE OF RELATED APPLICATION

This application claims priority from U.S. provisional patent application Ser. No. 60/844,699 titled “Dynamic Credit Card” filed on the 15^{th} of Sep. 2006.

### TECHNICAL FIELD

This invention relates to developing a card system where information associated with a card changes over time. Information associated with a card is only valid for a specific time window. This property would allow a user to use credit card information for any transaction guaranteeing that the same information can't be used to do another transaction at a different time.

### BACKGROUND

Over 800+ million internet population creates a mass market for online shopping. Online retail sales are hitting all time high exceeding 100+ billion US dollar a year. In those transactions, in general, cash can't be used directly. People use different payment system like Visa, Master card, debit card, pay pall, online check processing etc. Users simply enter their card information on online form to do online shopping and goods are delivered to their doors without any further interaction with the users. Sometimes consumers pay bill over phone where they need to provide their account information. However, all those consumers have one problem in common; the system doesn't guarantee that their financial information can't be reused at a later time. Often merchant store credit card information and some hacker can get hold of card information without card holder's knowledge. It would add significant value to card holder if their account information is not static and varies over time. In that case given account information can be used only for a limited time. If someone else stores account information then he can't use the same information for another transaction at a later time.

It is also common that a user buys something on the internet using credit card then sign some purchase agreement that simply enrolls him up for some membership plan setting up recurring payment using the same card information asking user to cancel after some trial period. That happens with a click of button and user didn't have time to read and decode legal agreement. User often forgets and merchants simply take advantage of the mistake of consumer and complexity of the system. It is also difficult for a user to trust the website he enter his account information. If a consumer could make sure that the merchant or anyone in the middle can't re-use his card information for another transaction, he could complete the initial purchase with a great peace of mind. A study shows that a good percentage of consumers often fears to do online transaction because they don't feel the system provide enough protection for them. This dynamic card concept will solve the problem where information associated with the account are time bound, not static and can't be reused at a different time.

The same problem exists for bank check writing and processing in regular banking system. It's easier than ever to duplicate a check if certain information is available such as account numbers, bank information, and range of check number and a copy of signature. Currently all information on a check are static and there is no way to check integrity of a check other than verifying signature. This is more problematic when the check is created on the fly based on user input. Because of this weakness in the system check fraud cost billions of dollars a year. Also the system can't be changed overnight. If some information on a check can be entered as dynamic information which is time bound then integrity of the check can be easily verified. This would make check fraud more difficult since that would require entering the dynamic information which can't be easily generated.

### The Proposed Method

The main idea is to use some information on the card that can be associated with an account and use them in non static or in dynamic form. Such information must be an essential component to complete a card transaction. Also that information will change over time to provide non-static nature to information currently printed or assigned to a card or account. We will discuss the proposed method with credit card like account.

### Credit Card System

Credit cards such as Visa Master cards or discover cards have few static information as bellow in visible form.

Card holder name

Card Number

Expiration Date

3 digit card verification code (CVC).

Card issuing organization name.

However the might more information encoded in the magnetic strip on the back of the card.

In the proposed system, an electronic circuit will be installed on the regular card that would generate some sequence of numbers at regular intervals. That number will be readable to user through some display. The circuit can be powered with some tiny battery, light source or some other mechanism. Those numbers can be used in place of static information on a card. For example expiration date can be replaced with such circuit which will generate sequence of valid expiration dates that keep changing all the time at a regular interval. When users do some online transactions they put all account information along with the displayed expiration date. Transaction processor sends collected information to the card issuer bank to get authorization for the transaction. The card issuer already knows that this particular card contains dynamic information. Card issuer also knows what circuit was installed on the card. From that information. Card issuer can create the expected expiration date for the issued card at any given time. If the created information matches with the information entered by the user card issuer authorizes the transaction. If someone tries to reuse the same information at a later time, card issuer will figure out that the expiration date didn't match and will decline the transaction. The same technique can be used for some digits in card numbers or in Card verification Code.

Thin display unit that generates numbers can be easily installed on the card without changing card dimension. For any given time and for a given card, card issuer should be able to generate the displayed number on the card, valid range of numbers within a particular timeframe. Card issuer might adopt different technique to generate numbers to assist smooth verification process. Display unit can be separate unit or can be part of the manufactured card where some hidden/detachable serial number would identify the sequencing properties of numbers. Card issuers need to keep the serial number before sending the card to users. That numbers can be used to generate the numbers user would see on his card at any given time. This would help to integrate the card with verification system.

A simple internal implementation of display unit might contain a stored table that contains a set of numbers. The display unit simply displays those numbers in sequence with a starting index at a predefined interval. The table, starting index, starting number, intervals all can be programmed during card creation time. Card issuer can keep that information. Also the table itself can be programmed to filter out certain numbers. There might be many other implementations of such circuits.

This idea can be expanded in different ways where the dynamic information generation can be kept anywhere user can access easily. For example, user can access his account online and get a number that can be used in place of static information on his card. Consumer can call customer service to get the dynamic number. This can make any credit card easily disposable or truly give one time use characteristics without changing the card.

It is also possible to keep the static and dynamic information side-by-side. User can use static information whenever needed. This would be helpful when user need to use the card for recurring bills.

Another embodiment might be something like user can use some device that would extract some dynamic information and put that back to magnetic strip on the card. This step would enable consumer to change information dynamically and use the same card in retail store.

Another embodiment might be a system where dynamic information changes only when certain conditions are met. For example, user can press a key to changes the number which then get propagated back to bank that this is the current number. Or user can simply access his account online to set a new dynamic expiry date within a range. Then the new information can be programmed back to magnetic strip if needed.

### Dynamic Check Processing System

A bank check contains some information as bellow:

a. routing number or ABA number

b. Account number

c. Date the check was signed

d. Check number

For printed bank check all the information above except date are pre printed. For online check processing user need to enter those information, void the check then merchant reprint the check and submit the check to the bank, basically user doesn't get a chance to sign the check but possibly some digital signature can be used. If user has a device that generates a sequence of number which is date bound then user can use those numbers as the prefix for check number or even account number. At the processing end, bank would verify the check number to see if that number was generated by the user device.

Carrying a separate device just for this purposes will be cumbersome, however at the beginning we described dynamic card that can generate dynamic numbers. Most of the bank offer card (like debit/credit) associated with the account and the dynamic information on card can be easily used for this purpose.

### LIST OF FIGURES

FIG. 1: Front side of a typical Credit Card

FIG. 2: Back Side of a typical Credit Card

FIG. 3: Front side of a proposed dynamic Credit Card

FIG. 4: Back Side of a proposed dynamic Credit Card.

FIG. 5: Typical Bank Check

FIG. 5: Proposed Dynamic Bank Check layout

### DESCRIPTION OF FIGURES

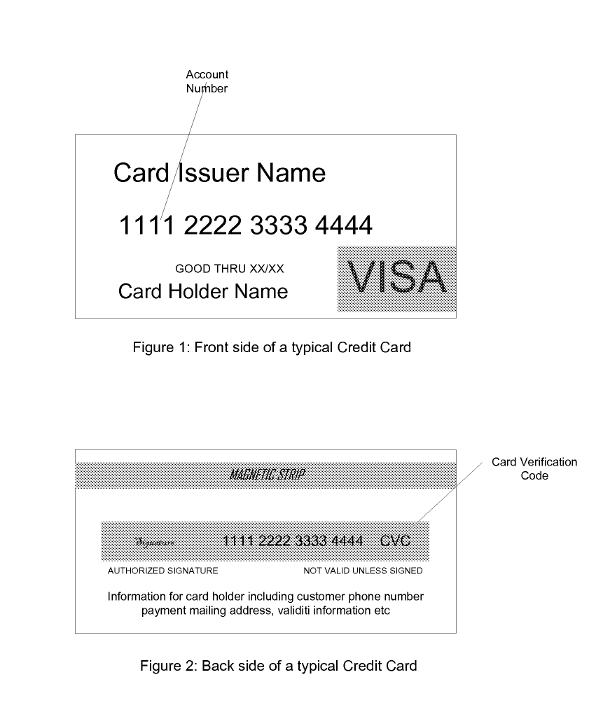

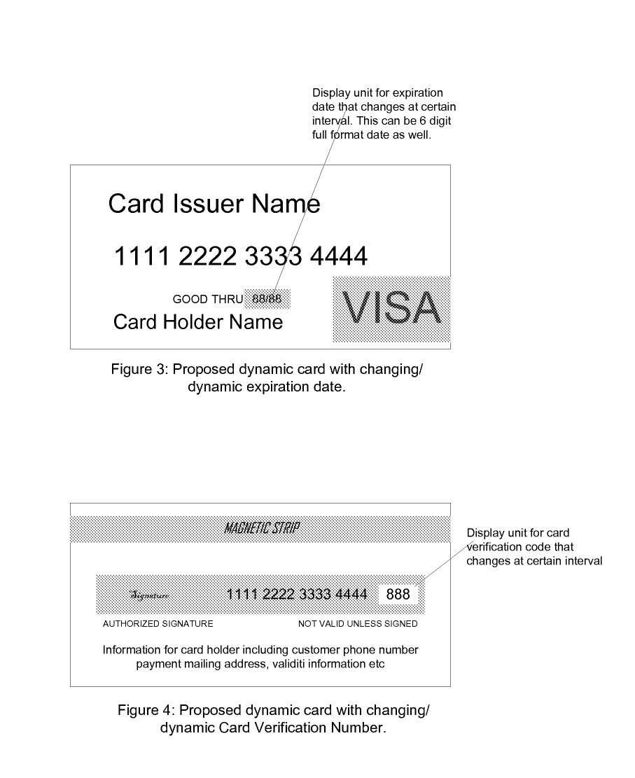

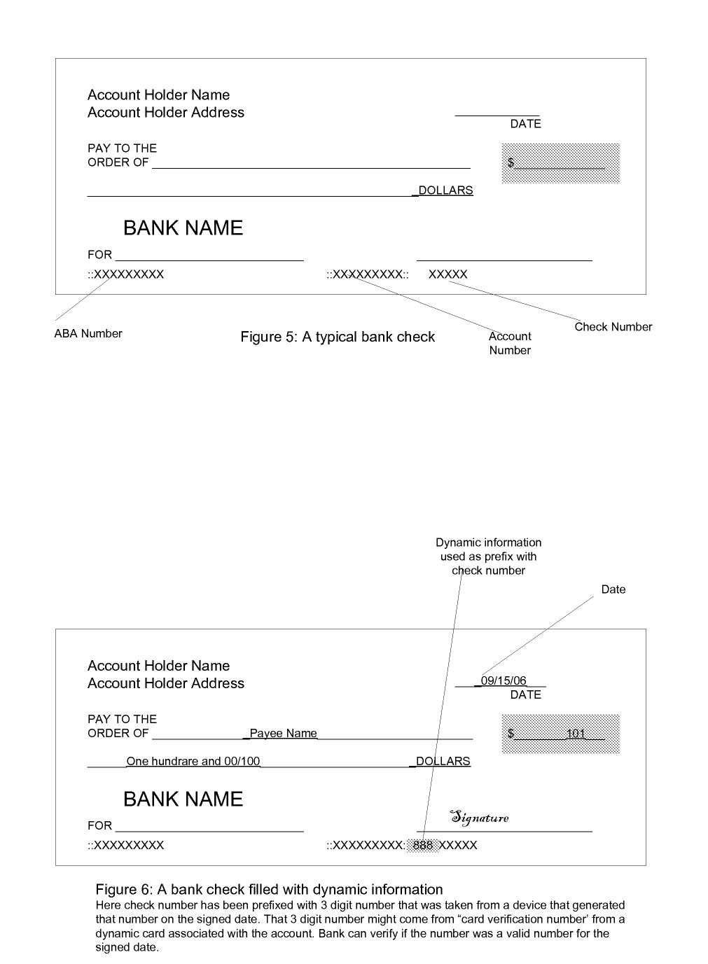

Credit card description in FIG. 1-2 and bank check description in FIG. 5 is self explanatory. In FIG. 1, “GOOD THRU” means expiratory date which can be 4 digits or 6 digits in some cards. FIG. 3 shows a display unit next to “GOOD THRU” that display 4 digit number. This can be 6 digits as well based on card type. The unit can be added at different location keeping the static information intact. FIG. 4 shows a display unit in place of Card verification Code. The display unit can replace the static CVC or can exist side by side. One thing to note is that the magnetic strip keeps the static information, however it is possible to program back the dynamic information in some instances.

FIG. 6 shows a layout for proposed dynamic check. The only difference is there are few extra spaces between account number and check number. User can fill up those spaces with dynamic number that becomes part of the check number.

### EXAMPLE EMBODIMENT OF THE SOLUTION

Let's assume a person Alex applies for a Credit card to a Bank called MyBank. My bank adopted the new proposed system where they can issue the new card with dynamic information. MyBank will create a new Credit card for Alex upon approval of the application. The new credit card will look like a regular credit card except it contains a slim display unit placed at the location of expiry date (or next to it). The display is powered by a think battery embedded in the unit. MyBank program the display unit in such a way so that it display a sequence of valid expire date within a particular range at an interval say 1 minute. Therefore at every one minute the date changes starting from a reference time. MyBank has a new verification unit that keep the card numbers and all the information the card was programmed with. Optionally MyBank can print the static expiry date so that Alex can use that card like a legacy card. Alex receives the card and activates the card just like a regular card. Alex can go to a gas station buy some gas with his new card. MyBank process that transaction as a regular transaction. Then Alex goes to internet site MyBook and tries to buy some book. Alex put all his card information on a form while making payment. In place of expiry date Alex put the date displayed on his card instead of static expiry date. MyBook site send those card information over the network and MyBank eventually receives the transaction authorization request. From the information MyBank knows that the expirer date is not the static date and the card is dynamic card. Then Mybank retrieve the information the card was programmed with. From the preprogrammed information MyBank generate the expected dynamic expiry date for the time transaction was posted. If the generated date matches the date that came through with the transaction request MyBank simply authorize the transaction. Sometimes there might be network latency between transaction was posted and MyBank receive the transaction in that case MyBank would generate few possible dates within a time windows around the transaction posted time and check if the provided information matches with any generated information within a range. It is also possible that Alex open a regular account with the bank and the back issue Alex a dynamic card attached to the account.

Alex also receives some checks from MyBank. Those checks were associated with his account. Checks come with check number with additional digits as blank to be filled out by Alex. When Ales write a check, we look at the display number on his card and put all those digits with the check number. Now the written digits along with old digits as a whole become new number. Alex put date on the check. When MyBank receives a copy of the check it retrieve Alex's account information and verify if the check number was supposed to be generated by the display unit on Alex's card on the date Alex signed the check. If that matches then check integrity was verified. If anyone else wants to fake as Alex writing the check then he must get hold of Alex's card 1^{st} to get the dynamic number. It is also possible that the check comes with number with few digits to be filled in as prefix which can be treated as dynamic information that might come from some numbers from a dynamic card associated with the account.

In the above example Merchant MyBook can't store the account information and process that at a later time. In the future, Card processing infrastructure can support to enter transaction origination time that can help to process the transaction at a later time provided merchant record the transaction origination time along with card information that might contains dynamic information.

The solution described in the previous section is completely compatible with current processing unit that is used to accept card or account information. The proposed solution doesn't introduce any new filed or new class of information to improve the current system. The only additional work need to be done are a) at the verification end, Bank or financial institution need to add this additional check b) on the user end, user need to understand the new numbers and its benefit and uses.

Foregoing embodiment uses expiry date and check numbers as a dynamic information. However any information associated with existing account can be used as dynamic information with or without some modifications. Such dynamic information can be used in many form, can be integrated with computer software, check writing devices, web services, online transaction processor etc. Some services can be created that can implement the similar system keeping the display unit as a separate unit. The display unit can move on a key ring, different account can be attached to the same display units. The verification process can be separated out from the back and another independent entity can manage the display unit and the verification process. The numbers in the display unit can be programmed in many ways to assist the need. It is possible to adopt the similar system in many possible combinations not outlined in this document.

What is claimed is:

1. A dynamic card system comprising:
a. a dynamic card consisting of a regular card with a means to produce non-static information that changes over time,
b. a Creation method to create dynamic card,
c. a validation method to validate the information coming from dynamic card, thus providing a way to conduct Card transaction making sure that information associated with the card posted for a transaction can't be re-used for doing another transaction at a later time.

2. Dynamic card as recited in claim 1 will have at least one user readable display unit.

3. Display unit(s) as recited in claim 2 will generate dynamic information defined as information that changes over time where such dynamic information will be used in place of at least one of the following static information associated with the card to conduct card transaction:
a. Card expiration date,
b. Card Verification code,
c. Few digits in the account number,
d. Any information readable on the card.

4. Dynamic card as recited in claim 1 will consist of a static credit card along with a separate detached unit or separate means that can generate dynamic information that can change over time.

5. Display unit as recited in claim 2 can be pre-programmed with some dynamic characteristics that would allow the unit to display numbers or information that changes over time at a predefined interval.

6. Display unit as recited in claim 2 can display numbers based on manual set where information changes after each manual intervention rather than being changed automatically.

7. Display unit as recited in claim 2 will display number from an internal table that store valid set of information or numbers using some parameters such as starting index, time period to keep information to display, starting time will be part of dynamic properties where another verification method can generate displayed information on the unit using dynamic properties without having the display unit.

8. Display unit as recited in claim 2, can generate number using any electronic circuit which was build using some dynamic properties where another verification method can generate the displayed information separately using the dynamic properties without having the display unit.

9. Creation method as recited in claim 1 will program the display unit by uploading some specific dynamic properties that would uniquely identify the display unit where a separate verification unit having access to those dynamic properties can generate displayed information on the display unit.

10. Creation method as recited in claim 1 will maintain or create another master table that would store table information or circuit properties of all the cards it creates.

11. Creation method as recited in claim 1 might create or import dynamic properties of a card based on some serial number.

12. Validation method as recited in claim 1 will retrieve table or circuit information or dynamic properties for any display unit embedded on a card using card number from a table.

13. Validation method as recited in claim 1 will generate the information displayed on the card display unit(s) at any given time using dynamic properties for the display unit which is called generated dynamic information.

14. After receiving a transaction request, Validation method as recited in claim 1 isolate dynamic information from the transaction info that will include one or more of a) expiration date b) Card verification Code or c) account number or d) any other info on the card, as posted dynamic information.

15. Verification method as recited in claim 1 will match generated dynamic information and posted dynamic information for a transaction and authorize the transaction if they match or decline the transaction if they do not match.

16. Verification method as recited in claim 1, will generate few sets of dynamic information within a specific time window the transaction is about to occur to allow some grace period where any set of generated dynamic information can be matched with the posted dynamic information to allow transaction that can't be routed to verification method immediately due to network latency or any other reason.

17. A method to use of element of static account information associated with a regular card or bank account comprising uses of:
a. expire date that changes over time,
b. card verification Code that changes over time,
c. portion of digits in account number that changes over time,
d. portion of check number that is not fixed, to complete financial transaction in such a way to make sure that portion or all information
used in the transaction can't be reused for another transaction at a later time.

18. A bank check writing and processing system where some information on the check is filled up with some dynamic information or number coming from another device or source, where such device or source is registered with the account, where integrity of the check information can be verified by a verification method at a later time on the basis that filled information was generated by the device or came from the source on the date the check was signed or written or created.

19. filled up information as recited in claim 18 can be part of account number check numbers or any other information user can legitimately put on the check.

20. Another device or source as recited in claim 18 will represent a dynamic card associated with the account capable of generating numbers where set of generated numbers on a day is different from another day within a specific period or any separate device that can generate dynamic information.
